(19) United States
(12) Patent Application Publication
(10) Pub. No.: US 2003/0174109 A1
(43) Pub. Date: Sep. 18, 2003

(54) Liquid crystal display device and its drive method, and camera system

(76) Inventors: Mitsuru Tateuchi, Kanagawa (JP); Takashi Aoyama, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/276,656

(22) PCT Filed: Mar. 19, 2002
(86) PCT No.: PCT/JP02/02614

(30) Foreign Application Priority Data
Mar. 21, 2001 (JP) 2001-79987

(51) Int. Cl. G09G 3/36

(52) U.S. Cl. 345/88

(57) ABSTRACT

The present invention provides an active matrix type liquid crystal display employing the line inversion driving. At the time of the wide mode display, in which specific area (black frame area) of the pixel unit (11) consisting of such as upper two rows and lower two rows are displayed in black, the liquid crystal display drives the gate lines (24₋₁, 24_{-y-1}) of odd number rows and the gate lines (24₋₂, 24_{-y}) of even number rows of the black frame area using driving pulses (1) and (2) of different lines which are generated by the driving pulse generating circuit (135), while sequentially outputs image signals whose polarity is inverted every 1H period to the signal lines (25₋₁˜25₋ₓ) via the horizontal switches (122₋₁˜122₋ₓ) to perform line inversion driving in the black frame area.

### TECHNICAL FIELD

The present invention relates to a liquid crystal display and a driving method thereof, and a camera system using the liquid crystal display as a display apparatus for monitoring picked up images.

### BACKGROUND ART

Recently, the widevision system (highvision system) with aspect ratio of 16:9 has been developed which is different from the conventional standard television system (such as NTSC system) with aspect ratio of 4:3, and also video cameras having a shooting mode for such widevision system have been sold.

When utilizing the widevision system, a display having a large screen is required. As such a display having a large screen, panel displays of a liquid crystal display (LCD) and an electro luminescence (EL) display, which do not require a broad set up area, are used appropriately. Especially, a liquid crystal display, which does not require much driving power in principle, is used also as an electric view finder (EVF), monitor, etc. of a video camera system.

In order to cope with different aspect ratio of the television system, it is necessary to change the aspect ratio of the television system accordingly. So as to display images corresponding to the widevision system with aspect ratio of 16:9 on a liquid crystal display of the standard television system with aspect ratio of 4:3, generally, several upper and lower rows (stages) of a pixel unit having pixels arranged in the form of a matrix are displayed in black to construct a wide mode screen.

As a driving manner of a liquid crystal display, there is known an active matrix driving manner (referred to as an active matrix type, hereinafter), in which independent pixel electrodes are arranged for respective pixels and switching elements of a thin film transistor (TFT) are connected to the respective pixel electrodes to selectively drive the pixels.

In the manufacturing process of such active matrix type liquid crystal displays, a TFT substrate on which a TFT is formed as switching elements and a confronting substrate on which a color filter and confronting electrodes are formed are put together and liquid crystal material is put into the two substrates to be enclosed to construct a liquid crystal display panel. In thus constructed liquid crystal display panel, orientation of the liquid crystal is controlled by the switching control of the TFT and application of voltage based on image signals, and transmittance of light is changed to display the image signals on a screen.

In the active matrix type liquid crystal display, generally, a timing generator and an analog signal driver receive image signals, horizontal and vertical synchronization signals (or composite image signals including horizontal and vertical synchronization signals), and the timing generator supplies various timing signals and the analog signal driver supplies alternately driven analog image signals, respectively, to the liquid crystal display panel to display the image signals on a screen.

The alternately driven analog image signals are analog signals whose polarity is inverted periodically with a reference voltage Vcom (referred to as a common voltage Vcom, hereinafter) being its inversion center. In case a direct voltage of the same polarity is continuously applied to liquid crystal, resistivity of liquid crystal (resistance inherent to material) is prone to be deteriorated. On the other hand, in case analog image signals are alternately driven, liquid crystal can be prevented from being deteriorated.

Furthermore, from a point of view of inversion timing of analog image signals, there are two driving patterns of field inversion driving and line (1H: one horizontal period) inversion driving. In the field inversion driving, analog image signals of one polarity are written to all pixels, and then the polarity of the analog image signals is inverted. On the other hand, in the line inversion driving, the polarity of analog image signals is inverted every transverse (horizontal direction) one line, and is further inverted every field.

When employing the line (1H) inversion driving, since pixel voltage of High side (+side) and that of Low side (−side) are close with each other in an intermediate signal level as compared with the field inversion driving, flicker cannot be seen advantageously. Thus, in the active matrix type liquid crystal display, the line inversion driving is generally employed.

In the active matrix type liquid crystal display employing the line inversion driving, when displaying upper and lower black area (referred to as black frame area, hereinafter) in the wide mode screen, conventionally, driving pulses are given in common to gate lines of the black frame area (upper 28 rows and lower 28 rows, respectively, in this example), and black level signals of the same polarity are written to respective pixels at one time to perform black display or display black signals on the black frame area, as shown in FIG. 1. In this case, in the upper and lower black frame area, pixel voltage of the same polarity can be retained. The retaining state of the pixel voltage is the field inversion driving in the black frame area. On the other hand, in the effective display area of the mid portion of the liquid crystal display panel, since the line inversion driving is employed, voltage of inverse polarity is retained at the upper and lower adjacent pixels.

However, in the active matrix type liquid crystal display employing the line inversion driving, as described above, in case the field inversion state and the line inversion state coexist from a point of view of the retaining state of the pixel voltage in the liquid crystal display panel when displaying the wide mode screen, it becomes difficult to adjust the common voltage Vcom. Furthermore, in case the common voltage Vcom is deviated from the optimum value, flicker and sticking may be raised, which may degrade image quality.

### DISCLOSURE OF THE INVENTION

Accordingly, the present invention has an object to overcome the above-mentioned drawbacks of the prior art by providing a liquid crystal display and a driving method thereof, and a camera system using the liquid crystal display as a display apparatus for monitoring picked up images, which can spread adjustment margin of the common voltage Vcom at the time of the wide mode display when displaying a wide mode screen using a standard mode screen, and can improve image quality.

The above object can be attained by providing a liquid crystal display capable of displaying a screen of different aspect ratio, which displays predetermined color signals on specific area of a pixel unit having pixels arranged in the form of a matrix, the specific area consisting of a plurality of upper and lower rows, including:

means for generating driving pulses of different lines to drive gate lines of odd number rows and gate lines of even number rows of the specific area when displaying the predetermined color signals on the specific area; and

means for supplying the predetermined color signals to the pixels of the specific area with the polarity of the color signals inverted every one horizontal period.

The liquid crystal display is used as a display apparatus for monitoring picked up images in a camera system such as a video camera.

According to the liquid crystal display and the camera system using the liquid crystal display, in displaying a screen of different aspect ratio, the odd number rows and the even number rows of the specific area are driven using the driving pulses of different lines, while the predetermined color signals are supplied to the pixels of the specific area with the polarity of the color signals inverted every one horizontal period to perform line inversion driving in the specific area as well as in image display area. Thus, the retaining voltage of pixels in the specific area is set to be of line inversion state similar to that in image display area. So, the common voltage Vcom can be adjusted easily.

These objects and other objects, features and advantages of the present invention will become more apparent from the following detailed description of the preferred embodiments of the present invention.

### BRIEF DESCRIPTION OF THE DRAWINGS

FIG. 1 shows a schematic view for explaining the conventional manner of performing black display on the black frame area.

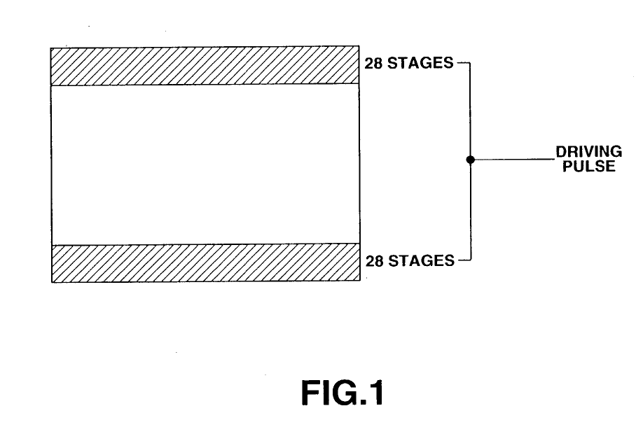

FIG. 2 shows the configuration of an active matrix type liquid crystal display according to the present invention.

FIG. 3 shows an example of a timing chart of driving pulses (1) and (2) of different lines.

FIG. 4 shows a schematic view for explaining the manner of performing black display on the black frame area according to the present invention.

FIG. 5 shows another example of a timing chart of driving pulses (1) and (2) of different lines.

FIG. 6 shows yet another example of a timing chart of driving pulses (1) and (2) of different lines.

FIG. 7 shows a specific block diagram of a driving pulse generating circuit, which generates preferred driving pulses (1) and (2).

FIG. 8 shows a timing chart (1) for explaining circuitry operation of the driving pulse generating circuit shown in FIG. 7.

FIG. 9 shows a timing chart (2) for explaining circuitry operation of the driving pulse generating circuit shown in FIG. 7.

FIG. 10 shows a block diagram of a camera system according to the present invention

### BEST MODE FOR CARRYING OUT THE INVENTION

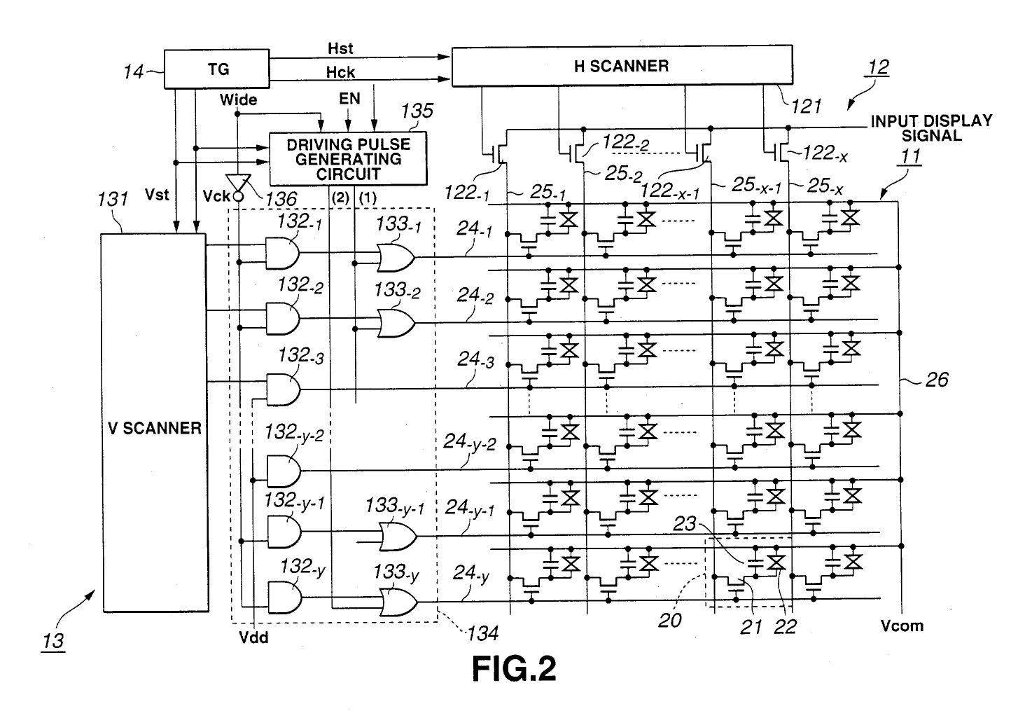

The present invention will further be described below concerning the best modes with reference to the accompanying drawings. FIG. 2 shows the configuration of an active matrix type liquid crystal display according to the present invention. The active matrix type liquid crystal display includes, as will be described later, a pixel unit (effective display area) 11 which has pixels arranged in the form of a matrix, a horizontal (H) driving system 12 for writing display data to respective pixels in the dot-sequential manner which may be arranged on the top side of the pixel unit 11, a vertical (V) driving system 13 for selecting respective pixels on the row unit which may be arranged on the left side of the pixel unit 11, and a timing generator (TG) 14 for generating various kinds of timing signals.

The pixel unit 11 is formed by putting two transparent insulated substrates (such as glass substrates) together, and putting liquid crystal material into the two substrates to enclose the material. In the pixel unit 11, each of pixels 20 which are arranged in the form of a matrix has a TFT (thin film transistor) 21 as a switching element, a liquid crystal cell 22 which has its pixel electrode connected to the drain electrode of the TFT 21, and an auxiliary capacitor 23 which has its one electrode connected to the drain electrode of the TFT 21.

In the pixel configuration, each TFT 21 of the respective pixels 20 has its gate electrode connected to one of gate lines 24₋₁, 24₋₂, . . . , 24_{-y-1}, 24_{-y} which are prepared for “y” rows, where the “y” corresponds to the number of pixel lines along the vertical direction (arrangement direction of rows) which will be referred to as vertical pixel number “Y” hereinafter, while having its source electrode connected to one of signal lines 25₋₁, 25₋₂, . . . , 25₋ₓ₋₁, 25₋ₓ which are prepared for “x” columns, where the “x” corresponds to the number of pixel lines along the horizontal direction (arrangement direction of columns) which will be referred to as horizontal pixel number “X” hereinafter. Also, each liquid crystal cell 22 and each auxiliary capacitor 23 have their other ends connected to a common line 26 to which the common voltage Vcom is supplied.

The horizontal driving system 12 includes an H scanner 121 being a shift register having stages corresponding to the horizontal pixel number “X”, and “x” sets of horizontal switches 122₋₁˜122₋ₓ arranged corresponding to the horizontal pixel number “X”. The H scanner 121 sequentially sends transfer pulses for the respective stages as horizontal scanning pulses, which are obtained by sequentially transferring horizontal start pulses Hst to direct horizontal scanning in synchronization with horizontal clocks Hck being the reference of the horizontal scanning. The horizontal switches 122₋₁˜122₋ₓ may be a MOS transistor which sequentially sends display data to the signal lines 25₋₁˜25₋ₓ of the pixel unit 11 when sequentially turned to be on state after responding to the horizontal scanning pulses sequentially output from the H scanner 121.

The vertical driving system 13 can display predetermined color signals (black, in this embodiment) on upper and lower area of a screen in changing the display mode from the standard mode corresponding to the standard television system with aspect ratio of 4:3 to the wide mode corresponding to the widevision system with aspect ratio of 16:9. For the convenience of simplification of drawings, as one example, the case in which upper two rows and lower two rows are to be displayed in black will be explained.

Specifically, the vertical driving system 13 includes a V scanner 131 being a shift register having stages corresponding to the vertical pixel number “Y”, a logic control circuit 134 having “y” sets of AND circuits 132₋₁˜132_{-y} and “y” sets of OR circuits 133₋₁˜133_{-y}, a driving pulse generating circuit 135 for generating driving pulses (1) and (2), and an inverter 136.

In the vertical driving system 13, the V scanner 131 sequentially sends transfer pulses for the respective stages as vertical scanning pulses, which are obtained by sequentially transferring vertical start pulses Vst to direct vertical scanning in synchronization with vertical clocks Vck being the reference of the vertical scanning. These vertical scanning pulses are sent to the AND circuits 132₋₁˜132_{-y} as their one input signal.

Of the AND circuits 132₋₁˜132_{-y}, each of the AND circuits 132₋₁, 132₋₂ corresponding to upper two rows and the AND circuits 132_{-y-1}, 132_{-y} corresponding to lower two rows which perform black display on the black frame area (black display area) of the pixel unit 11 is supplied with a wide mode control signal Wide in common via the inverter 136 as their other input signal, which becomes “H” level at the time of the wide mode display. On the other hand, each of the AND circuits 132₋₃˜132_{-y-2} corresponding to 3˜(y−2) rows which perform image display on the mid image display area of the pixel unit 11, excluding the black frame area and corresponding to the wide mode screen, is supplied with a positive power voltage Vdd in common as their other input signal.

Output signals of the AND circuits 132₋₁˜132_{-y} are send to the OR circuits 133₋₁˜133_{-y} correspondingly as their one input signal. At this time, of the OR circuits 133₋₁, 132₋₂, 133_{-y-1}, and 133_{-y} which correspond to the black frame area, each of the OR circuits 133₋₁, 133_{-y-1}, of odd number rows is supplied with a driving pulse (1) generated by the driving pulse generating circuit 135 as their other input signal, while each of the OR circuits 133₋₂, 133_{-y}, of even number rows is supplied with a driving pulse (2) generated by the driving pulse generating circuit 135 as their other input signal.

On the other hand, each of the OR circuits 133₋₃˜133_{-y-2} corresponding to the mid image display area excluding the black frame area is supplied with a GND level (a negative power voltage Vss) as their other input signal. Output signals of the OR circuits 133₋₁˜133_{-y} are output to the gate lines 24₋₁˜24_{-y} of the pixel unit 11, correspondingly. In this case, the OR circuits 133₋₃˜133_{-y-2} corresponding to the mid image display area excluding the black frame area may be omitted. That is, similar effect can be obtained by outputting the vertical scanning pulses from the V scanner 131 for the mid image display area of the pixel unit 11, excluding the black frame area, directly to the gate lines 24₋₃˜24_{-y-2} via the AND circuits 132₋₃˜132_{-y-2}.

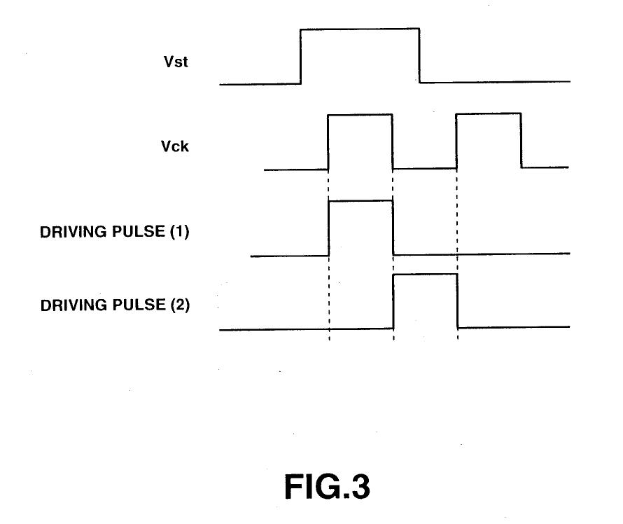

In case the wide mode control signal Wide supplied from outside is “H” level or in wide mode, the driving pulse generating circuit 135 generates the driving pulses (1) and (2) of different lines which are different in phase in synchronization with the vertical clocks Vck when the vertical start pulses Vst are generated, as shown in FIG. 3 depicting a timing chart. For example, the driving pulse generating circuit 135 generates the driving pulse (1) in case the vertical clock Vck is “H” level, while generating the driving pulse (2) in case the vertical clock Vck is “L” level.

The timing generator 14 generates various timing signals of the horizontal start pulses Hst and the horizontal clocks Hck to be supplied to the H scanner 121, the vertical start pulses Vst and the vertical clocks Vck to be supplied to the V scanner 131 and to the driving pulse generating circuit 135, and other timing signals.

The above-described circuit configuration of the vertical driving system 13 is one example, and the present invention is not restricted to this embodiment. So, various modifications are possible so long as the vertical driving system 13 is of a circuit configuration which can perform black display on the upper and lower black frame area of the pixel unit 11 at the time of the wide mode display.

Next, operation of the active matrix type liquid crystal display will be explained.

Firstly, when the display mode is set to be the wide mode, the timing generator 14 generates the wide mode control signal Wide. Thus, since other input signal of each of AND circuits 132₋₁, 132₋₂, 132_{-y-1}, and 132_{-y} becomes “L” level, the vertical scanning pulses generated from the V scanner 131 are not output to the gate lines 24₋₁, 24₋₂, 24_{-y-1}, and 24_{-y} of the black frame area.

Instead, the driving pulses (1) and (2) of different lines sent from the driving pulse generating circuit 135 are output to the gate lines 24₋₁, 24₋₂, 24_{-y-1}, and 24_{-y} of the black frame area. Specifically, the driving pulses (1) are output to the gate lines 24₋₁, 24_{-y-1} of odd number rows via the OR circuits 133₋₁, 133_{-y-1}, while the driving pulses (2) are output to the gate lines 24₋₂, 24_{-y} of even number rows via the OR circuits 133₋₂, 133_{-y}.

On the other hand, as for the mid image display area excluding the black frame area, similar to the standard mode case, the vertical scanning pulses generated by the V scanner 131 are output to the gate lines 24₋₃˜24_{-y-2} via the AND circuits 132₋₃˜132_{-y-2} and the OR circuits 133₋₃˜133_{-y-2}, while image signals whose polarity is inverted every 1H period are sequentially supplied to the signal lines 25₋₁˜25₋ₓ via the horizontal switches 122₋₁˜122₋ₓ. Thus, image display corresponding to the widevision can be performed in the dot-sequential manner.

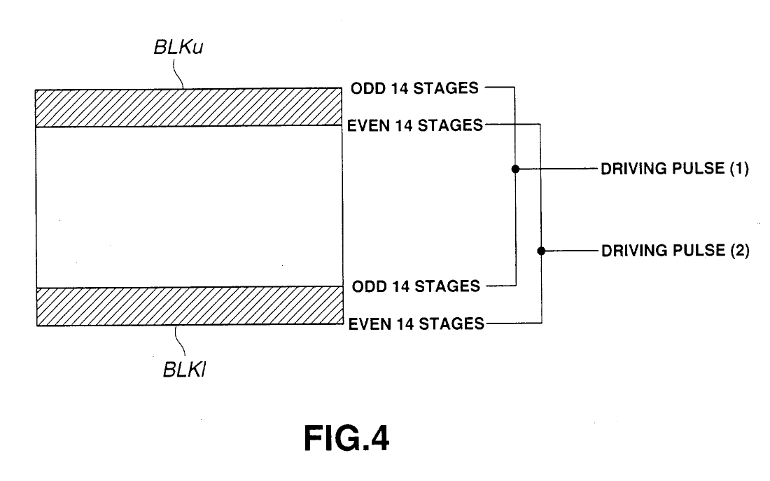

Next, black display on the black frame area will be explained with reference to FIG. 4. In the following explanation, the display screen is switched to the wide mode screen by converting upper 28 stages (rows) and lower 28 stages (rows) of the effective display area corresponding to the standard mode into the black frame area BLKu, BLKl at the time of setting the display mode to be the wide mode.

Firstly, each of the upper and lower black frame area BLKu, BLKl are composed of odd 14 stages and even 14 stages, respectively, and the driving pulses (1) and (2) of different lines are sent thereto. That is, the driving pulses (1) are sent to the odd stages, while the driving pulses (2) are sent to the even stages, respectively. On the other hand, black level signals are sequentially output to the signal lines 25₋₁˜25₋ₓ via the horizontal switches 122₋₁˜122_{-X}. The black level signals are signals whose polarity is inverted every one horizontal period (1H).

As shown in the timing chart of FIG. 3, when the driving pulses (1) of “H” level are output to the odd stages of the black frame area BLKu, BLKl, the black level signals of certain polarity are written to respective pixels of the odd stages. At this time, since the driving pulses (2) for the even stages are “L” level, the black level signals are not written to respective pixels of the even stages. Next, the driving pulses (2) become “H” level, and when the driving pulses (2) of “H” level are output to the even stages of the black frame area BLKu, BLKl, the black level signals of inverted polarity are written to respective pixels of the even stages. At this time, since the driving pulses (1) for the odd stages have been changed to “L” level, the black level signals are not written to respective pixels of the odd stages.

Above-described operation is performed under the field period. Thus, in the black frame area, black level signals of inverted polarity are written to pixels adjacent to each other along the upward and downward direction. That is, similar to the image display area, line (1H) inversion driving is performed in the black frame area.

As has been described above, in the active matrix type liquid crystal display which can display a wide mode screen using a standard mode screen whose aspect ratio is 4:3, line inversion driving is performed in the upper and lower black frame area BLKu, BLKl similar to the image display area at the time of the wide mode display. Thus, only the line inversion state exists as the retaining voltage of pixels when displaying the wide mode screen. So, the common voltage Vcom can be adjusted easily, which can improve image quality.

In the above-described active matrix type liquid crystal display according to the invention, when displaying a wide mode screen, in any field, the driving pulses (1) are output to the odd stages firstly, and then the driving pulses (2) are output to the even stages, which order of controlling the odd stages and the even stages is equal in each field. On the other hand, the controlling order does not need to be equal, and the order of controlling the odd stages and the even stages may be changed every field.

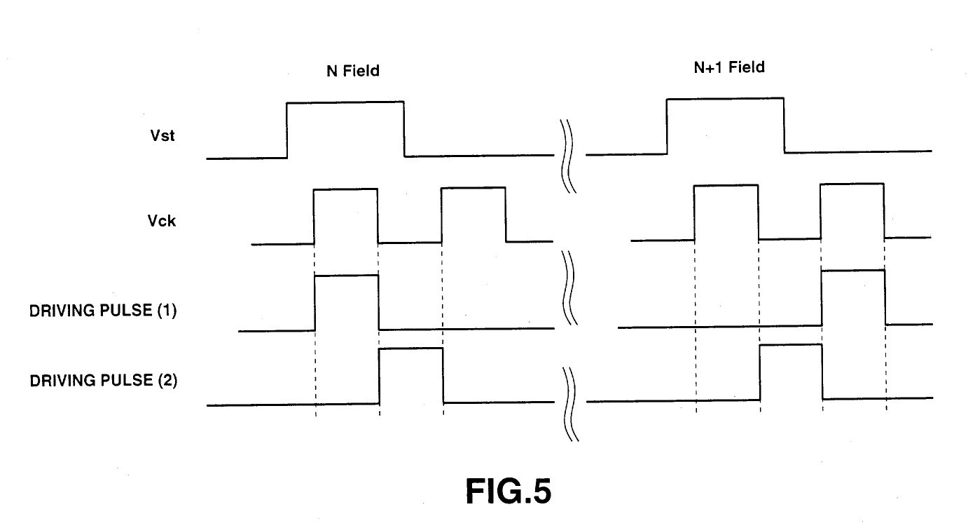

Specifically, in the driving pulse generating circuit 135 of FIG. 2, in N field, the driving pulse (1) is generated firstly in synchronisation with the vertical clock Vck and the driving pulse (2) is generated next, while in N+1 field, inversely, the driving pulse (2) is generated firstly in synchronisation with the vertical clock Vck and the driving pulse (1) is generated next, as shown in the timing chart of FIG. 5.

Thus, when displaying a wide mode screen, in the N field, the driving pulses (1) are output to the odd stages firstly and the driving pulses (2) are output to the even stages next, while in the N+1 field, the driving pulses (2) are output to the even stages firstly and the driving pulses (1) are output to the odd stages next. That is, the controlling order in the N field is from odd stages to even stages, that in the N+1 field is from even stages to odd stages, that in the N+2 field is from odd stages to even stages, and that in the N+3 field is from even stages to odd stages. Thus, the controlling order of the odd stages and even stages is changed every field.

In case the controlling order of the odd stages and the even stages is not changed every field, since the driving pulse (2) is generated continuously just after the driving pulse (1) is generated, the retaining voltage of pixels of the odd stages is affected by coupling due to parasitic capacity just after the driving pulse (1) is extinguished. Then, the affection is repeated in the same way every field, which may deteriorate image quality.

On the other hand, as described above, when the controlling order of the odd stages and the even stages is changed every field, the odd stages are affected by the coupling in the N field firstly, and the even stages are affected by the coupling in the N+1 field next. Thus, the state affected by the coupling is changed in each field and is offset visually. So, image quality is not deteriorated by the affection of the coupling, which can improve image quality.

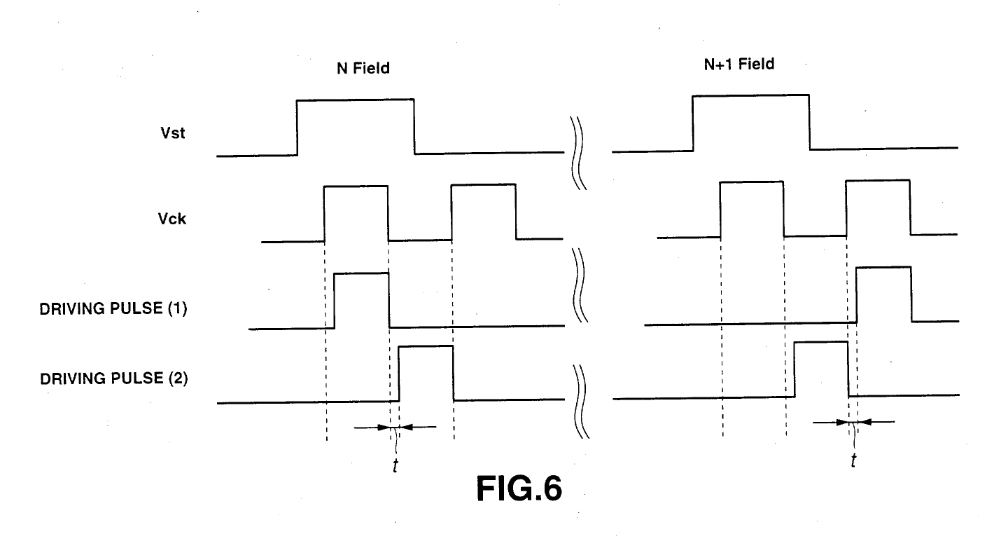

Furthermore, in generating the driving pulses (1) and the driving pulses (2), as shown in the timing chart of FIG. 6, it is desirable that the driving pulse (1) and the driving pulse (2) do not overlap each other by causing the driving pulse (1) and the driving pulse (2) to have interval “t” therebetween. Thus, even though there is generated waveform change due to parasitic capacity of lines which transmit the driving pulses (1) and (2), the driving pulses (1) and (2) are prevented from overlapping with each other due to the existence of the interval “t”. Thus, stripe noises due to the overlap which may be raised when black level signals of the same polarity are concurrently written to the odd stages and to the even stages can be prevented in advance, which can further improve image quality.

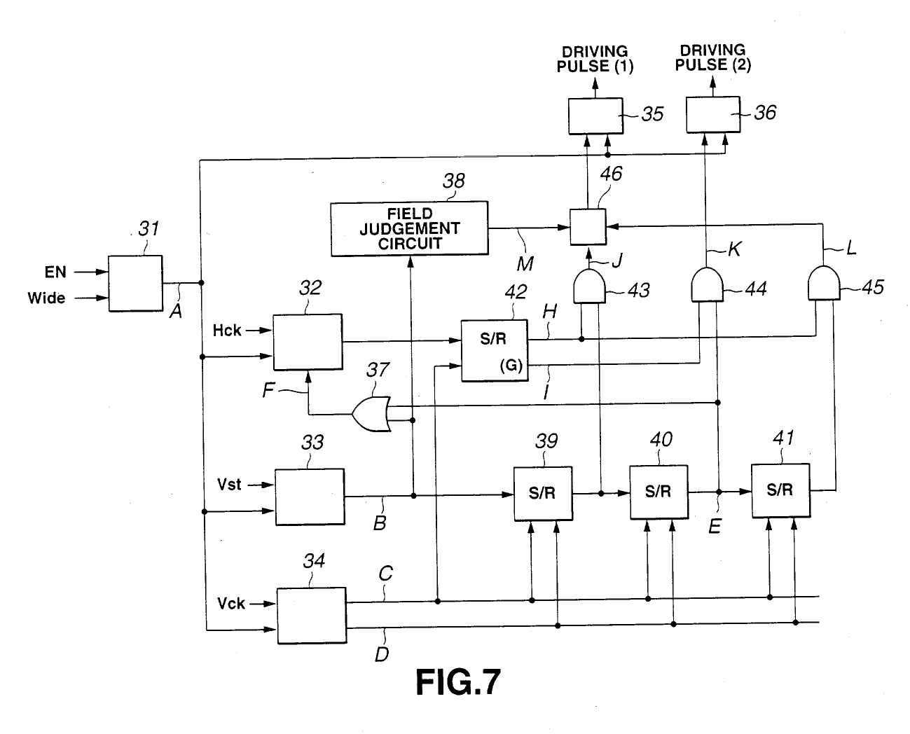

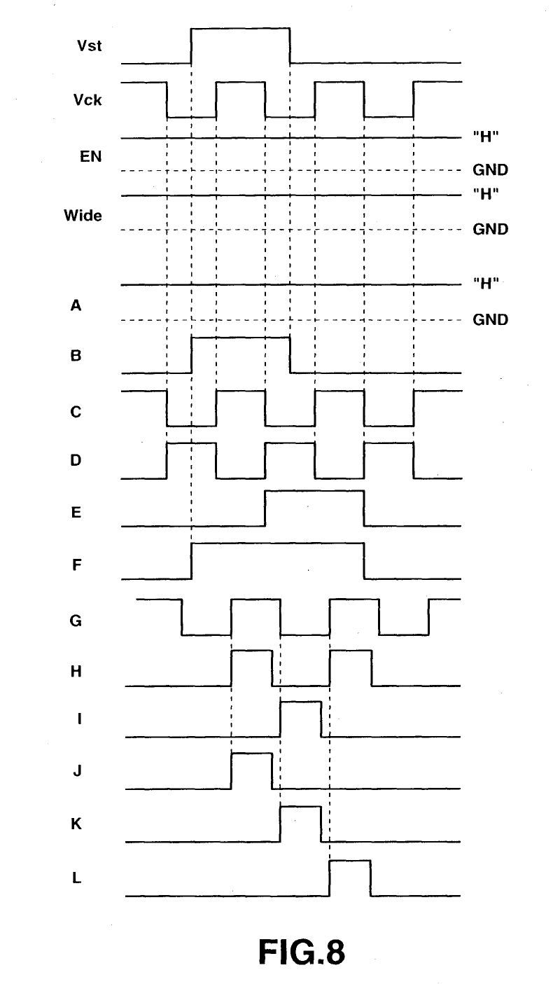

FIG. 7 shows a specific block diagram of the driving pulse generating circuit 135, which generates preferred driving pulses (1) and (2), that is, the driving pulses (1) and (2) shown in the timing chart of FIG. 6. FIG. 8 shows the timing relationship between the vertical start pulse Vst, the vertical clock Vck, an enable signal EN, the wide mode control signal Wide, and signals A˜L of respective units.

The driving pulse generating circuit 135 receives the enable signal EN and wide mode control signal Wide of “H” level, respectively, from outside, at the time of the wide mode display. Receiving the enable signal EN and the wide mode control signal Wide of “H” level, a mode detecting circuit 31 outputs a wide mode judgement signal A of “H” level. The wide mode judgement signal A is sent to level shifters 32˜34 and to buffers 35, 36.

The level shifter 33 receives the vertical start pulse Vst, and is caused to be in operational state on receiving the wide mode judgement signal A. The level shifter 33 level-shifts the vertical start pulse Vst to output a pulse signal B. The level shifter 34 receives the vertical clock Vck, and is caused to be in operational state on receiving the wide mode judgement signal A. The level shifter 34 level-shifts the vertical clock Vck to output a clock signal C of the same phase and a clock signal D of inverted phase.

The pulse signal B is sent as one input signal to an OR circuit 37, and is sent also to a field judgement circuit 38, and to shift registers 39, 40, 41 where the pulse signal B is shifted sequentially. The clock signals C and D, whose phases are inverse with each other, are sent to the shift registers 39, 40, 41 as their clock signals. The clock signal C is sent also to a shift register 42.

Output signals from the shift registers 39, 40, 41 are sent as one input signal to AND circuits 43, 44, 45. Also, an output signal E from the shift register 40 is sent as the other input signal to the OR circuit 37. An output signal F from the OR circuit 37 is sent to the level shifter 32. The level shifter 32 receives the horizontal clock Hck, and is caused to be in operational state on receiving the wide mode judgement signal A. The level shifter 32 level-shifts the horizontal clock Hck during a period the output signal F is supplied thereto and outputs a resulting signal to the down stream shift register 42 as its clock signal.

The shift register 42 shifts the clock signal (vertical clock Vck) C in synchronization with the horizontal clock Hck to generate a signal G in the inside thereof. Then, the shift register 42 outputs a signal H having two pulses which has its pulse width reduced by above-described “t” as compared with the signal G in the rise timing of the signal G, and outputs a signal I having one pulse which has its pulse width reduced by above-described “t” as compared with the signal G in the fall timing of the signal G. The signal H is sent as the other input signal to the AND circuits 43, 45, while the signal I is sent as the other input signal to the AND circuit 44.

Then, the AND circuits 43, 44, 45 sends pulse signals J, K, L which have the interval “t” arranged therebetween. Of the pulse signals J, K, L, two signals of the pulse signals J, L are sent to a switching circuit 46, which selects either of the received signals to send thus selected signal to the buffer 35. The pulse signal K is sent directly to the buffer 36.

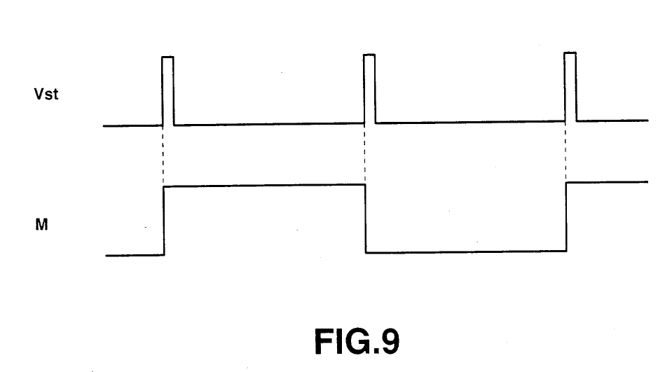

The field judgement circuit 38 may be a T-type flip-flop circuit. On receiving the pulse signal (vertical start pulse Vst) B sent from the level shifter 33 as an input trigger signal, the field judgement circuit 38 outputs a field judgement signal M whose polarity is caused to be inverted every time a pulse of the pulse signal B is given thereto, as shown in the timing chart of FIG. 9. For example, the field becomes odd field when the polarity of the field judgement signal M is “H” level, while the field becomes even field when the polarity of the field judgement signal M is “L” level.

The field judgement signal M is sent to the switching circuit 46 as its switching control signal. The switching circuit 46 selects the pulse signal J when the field judgement signal M is “H” level, while selects the pulse signal L when the field judgement signal M is “L” level. Then, the switching circuit 46 sends thus selected signal to the buffer 35. That is, the pulse signal J and the pulse signal L are alternately selected every field by the switching circuit 46.

On receiving the wide mode judgement signal A, the buffers 35, 36 are caused to be in operational state. Then, the buffer 35 sends the pulse signal J and the pulse signal L alternately every field as the driving pulse (1), while the buffer 36 always sends the pulse signal K regardless of the field as the driving pulse (2).

By employing thus configured driving pulse generating circuit 135, as shown in the timing chart of FIG. 6, in N field, the driving pulse (1) is generated firstly in synchronisation with the vertical clock Vck and the driving pulse (2) is generated next, while in N+1 field, inversely, the driving pulse (2) is generated firstly in synchronisation with the vertical clock Vck and the driving pulse (1) is generated next. And furthermore, it becomes possible to generate the driving pulse (1) and the driving pulse (2) which do not overlap each other by causing the driving pulse (1) and the driving pulse (2) to have interval “t” therebetween.

The driving pulse generating circuit 135, which generates the driving pulses (1) and (2), may be arranged on a substrate (liquid crystal display panel) together with the pixel unit 11, the horizontal driving system 12, and the vertical driving system 13, in which case the driving pulses (1) and (2) are generated inside the liquid crystal display panel using controlling pulses supplied from the outside. On the other hand, the driving pulse generating circuit 135 may be arranged at the outside of the liquid crystal display panel, in which case the driving pulses (1) and (2) are generated outside the liquid crystal display panel and are supplied thereto.

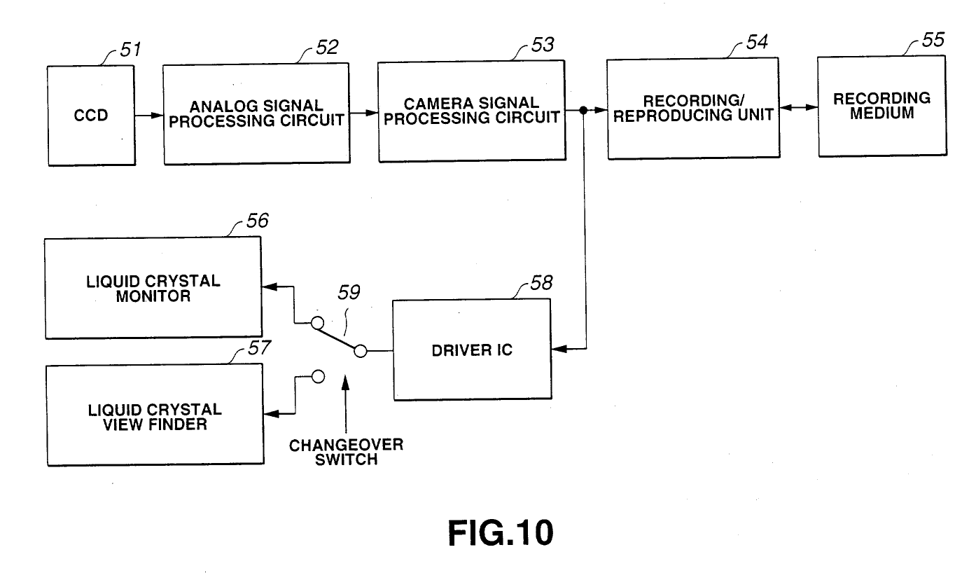

FIG. 10 shows a block diagram of a camera system according to the present invention, which may be a video camera called camcorder having such as VTR function integrated therein. In FIG. 10, a subject is picked up by a pickup device such as a CCD (Charge Coupled Device) pickup unit 51, and picked up signals are sent to an analog signal processing circuit 52 and then to a camera signal processing circuit 53, where the picked up signals undergo various signal processing.

Specifically, the analog signal processing circuit 52 performs, for the picked up signals sent from the CCD pickup unit 51, CDS (Correlated Double Sampling) processing to remove 1/f noise generated when the picked up signals are outputted from the CCD pickup unit 51, and AGC (Automatic Gain Control) processing to level the picked up signals. Also, the camera signal processing circuit 53 performs signal processing such as generation of luminance signals and color difference signals, image quality adjustment of auto white balance, etc., in the digital processing manner, and finally outputs analog image signals.

Then, thus generated analog image signals are sent to a recording/reproducing unit 54. The recording/reproducing unit 54 records received analog image signals to a recording medium 55 such as a magnetic tape (or stores received analog image signals to a storing medium such as an image memory), and reproduces information recorded in the recording medium 55.

The camcorder has a liquid crystal monitor 56 and a liquid crystal view finder 57 as display units for confirming a subject (picked up image) being shot. The above-described active matrix type liquid crystal display according to the present invention is used as the liquid crystal monitor 56 and the liquid crystal view finder 57. Analog image signals which are alternately driven by a driver IC 58 with the common voltage Vcom being its center are selectively sent to the liquid crystal monitor 56 or the liquid crystal view finder 57 via a changeover switch 59.

As in the above, according to the camcorder of the present invention, the liquid crystal monitor 56 and the liquid crystal view finder 57 which are configured employing the above-described active matrix type liquid crystal display according to the present invention can be adapted not only to the standard television system but also to the widevision system whose aspect ratio is different from that of the television system. Furthermore, image quality at the time of the wide mode display can be improved.

According to the present invention, both of the liquid crystal monitor 56 and the liquid crystal view finder 57 employ the active matrix type liquid crystal display according to the present invention. On the other hand, either of the liquid crystal monitor 56 or the liquid crystal view finder 57 may employ the active matrix type liquid crystal display. Also, a video camera or a still camera which has either of the liquid crystal monitor 56 or the liquid crystal view finder 57 may employ the active matrix type liquid crystal display.

### INDUSTRIAL APPLICABILITY

As in the above, according to the present invention, in displaying a screen of different aspect ratio, since the odd number rows and the even number rows of the upper and lower specific area of the pixel unit are driven using the driving pulses of different lines, while line inversion driving is performed in the specific area as well as in the image display area. Thus, the retaining voltage of pixels in the specific area is line inversion state similar to that in image display area at the time of the wide mode display, which can spread adjustment margin of the common voltage, and can improve image quality.

1. A liquid crystal display capable of displaying a screen of different aspect ratio, which displays predetermined color signals on specific area of a pixel unit having pixels arranged in the form of a matrix, the specific area consisting of a plurality of upper and lower rows, comprising:
means for generating driving pulses of different lines to drive gate lines of odd number rows and gate lines of even number rows of the specific area when displaying the predetermined color signals on the specific area; and
means for supplying the predetermined color signals to the pixels of the specific area with the polarity of the color signals inverted every one horizontal period.

2. The liquid crystal display as set forth in claim 1, wherein the driving means causes the driving pulses of different lines to have interval therebetween when generating the driving pulses.

3. The liquid crystal display as set forth in claim 1, wherein the driving means changes the order of driving the gate lines of odd number rows and the gate lines of even number rows every field.

4. The liquid crystal display as set forth in claim 3, wherein the driving means causes the driving pulses of different lines to have interval therebetween when generating the driving pulses.

5. A method for driving a liquid crystal display capable of displaying a screen of different aspect ratio, which displays predetermined color signals on specific area of a pixel unit having pixels arranged in the form of a matrix, the specific area consisting of a plurality of upper and lower rows, which
generates driving pulses of different lines to drive gate lines of odd number rows and gate lines of even number rows of the specific area when displaying the predetermined color signals on the specific area, while
supplies the predetermined color signals to the pixels of the specific area with the polarity of the color signals inverted every one horizontal period.

6. The method for driving a liquid crystal display as set forth in claim 5, wherein the driving pulses of different lines are caused to have interval therebetween.

7. The method for driving a liquid crystal display as set forth in claim 5, wherein the order of driving the gate lines of odd number rows and the gate lines of even number rows are changed every field.

8. The method for driving a liquid crystal display as set forth in claim 7, wherein the driving pulses of different lines are caused to have interval therebetween.

9. A camera system which has a liquid crystal display for monitoring picked up images,
the liquid crystal display being capable of displaying a screen of different aspect ratio and displaying predetermined color signals on specific area of a pixel unit having pixels arranged in the form of a matrix, the specific area consisting of a plurality of upper and lower rows, comprising:
means for generating driving pulses of different lines to drive gate lines of odd number rows and gate lines of even number rows of the specific area when displaying the predetermined color signals on the specific area; and
means for supplying the predetermined color signals to the pixels of the specific area with the polarity of the color signals inverted every one horizontal period.
